(19) United States
(12) Patent Application Publication
(10) Pub. No.: US 2025/0168915 A1
(43) Pub. Date: May 22, 2025

(54) NETWORK CONNECTION METHOD, ELECTRONIC DEVICE, READABLE STORAGE MEDIUM, AND CHIP

(71) Applicant: VIVO MOBILE COMMUNICATION CO., LTD., Dongguan (CN)

(72) Inventor: Xu LIU, Dongguan (CN)

(73) Assignee: VIVO MOBILE COMMUNICATION CO., LTD., Dongguan (CN)

(21) Appl. No.: 19/033,386

(22) Filed: Jan. 21, 2025

Related U.S. Application Data
(63) Continuation of application No. PCT/CN2023/110689, filed on Aug. 2, 2023.

(30) Foreign Application Priority Data
Aug. 5, 2022 (CN) 202210936716.7

(51) Int. Cl. H04W 76/19; H04W 76/11

(52) U.S. Cl. CPC H04W 76/19; H04W 76/11

(57) ABSTRACT

This application provides a network connection method, an electronic device, a readable storage medium, and a chip. The network connection method is executed to an electronic device, and the method includes: when the electronic device establishes a network connection to a first Standalone (SA) cell, obtaining release status information of a first Protocol Data Unit (PDU) session; and when it is determined, based on the release status information, that the first SA cell is in an abnormal state, establishing a network connection to a target cell. The first PDU session is a PDU session between the electronic device and the first SA cell. The target cell is a cell other than the first SA cell.

### CROSS-REFERENCE TO RELATED APPLICATIONS

This application is a continuation of International Application No. PCT/CN 2023/110689, filed on Aug. 2, 2023, which claims priority to Chinese Patent Application No. 202210936716.7, filed on Aug. 5, 2022. The entire contents of each of the above-referenced applications are expressly incorporated herein by reference.

### TECHNICAL FIELD

This application relates to the field of network connection technologies, and in particular, to a network connection method, an electronic device, a readable storage medium, and a chip.

### BACKGROUND

In a related technology, in some densely populated places, a Standalone (SA) cell corresponding to the place may be unable to simultaneously provide network services for all users in the place. As a result, some users may fail to successfully connect to a network, or network connections are released after some users successfully connect to the network. It can be learned that a problem of a relatively poor connection effect exists in an existing network connection method.

### SUMMARY

This application provides a network connection method, an electronic device, a readable storage medium, and a chip.

According to a first aspect, an embodiment of this application provides a network connection method applied to an electronic device, and the method includes:
in a case that the electronic device establishes a network connection to a first standalone SA cell, obtaining release status information of a first protocol data unit PDU session, where the first PDU session is a PDU session between the electronic device and the first SA cell; and
in a case that it is determined, based on the release status information, that the first SA cell is in an abnormal state, establishing a network connection to a target cell, where the target cell is a cell other than the first SA cell.

According to a second aspect, an embodiment of this application provides an electronic device, including:
an obtaining module, configured to: in a case that the electronic device establishes a network connection to a first standalone SA cell, obtain release status information of a first protocol data unit PDU session, where the first PDU session is a PDU session between the electronic device and the first SA cell; and
a connection module, configured to: in a case that it is determined, based on the release status information, that the first SA cell is in an abnormal state, establish a network connection to a target cell, where the target cell is a cell other than the first SA cell.

According to a third aspect, an embodiment of this application provides an electronic device, including a processor, a memory, and a program or an instruction that is stored in the memory and that is capable of being run on the processor, and when the program or the instruction is executed by the processor, the steps according to the first aspect are implemented.

According to a fourth aspect, an embodiment of this application provides a readable storage medium. The readable storage medium stores a program or an instruction, and when the program or the instruction is executed by a processor, the steps according to the first aspect are implemented.

According to a fifth aspect, an embodiment of this application provides a chip. The chip includes a processor and a communication interface, the communication interface is coupled to the processor, the processor is configured to run a program or an instruction, and when the program or the instruction is executed by the processor, the steps according to the first aspect are implemented.

In the embodiments of this application, in a case that an electronic device establishes a network connection to a first SA cell, whether the first SA cell is in an abnormal state is determined based on release status information of a first PDU session, and in a case that the first SA cell is in an abnormal state, a network connection between the electronic device and a target cell is established. In this way, because whether the first SA cell is in an abnormal state may be identified in a timely manner based on the release status information of the first PDU session, and in a case that it is recognized that the first SA cell is in an abnormal state, a network connection of the electronic device is switched to another cell, so that the electronic device stores a normal network connection.

### BRIEF DESCRIPTION OF DRAWINGS

FIG. 1 is a first schematic flowchart of a network connection method according to an embodiment of this application;

FIG. 2 is a second schematic flowchart of a network connection method according to an embodiment of this application;

FIG. 3 is a third schematic flowchart of a network connection method according to an embodiment of this application;

FIG. 4 is a first schematic diagram of a structure of an electronic device according to an embodiment of this application;

FIG. 5 is a second schematic diagram of a structure of an electronic device according to an embodiment of this application;

FIG. 6 is a schematic diagram of a structure of another electronic device according to an embodiment of this application; and

FIG. 7 is a schematic diagram of a hardware structure of an electronic device according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms such as “first” and “second” are used for distinguishing similar objects, and are not necessarily used to describe a particular order or sequence. It should be understood that terms used in such a way are interchangeable in proper circumstances, so that embodiments of this application can be implemented in an order other than the order illustrated or described herein. Objects classified by “first”, “second”, and the like are usually of a same type, and a quantity of objects is not limited. For example, there may be one or more first objects. In addition, in this specification and the claims, “and/or” indicates at least one of connected objects, and a character “/” generally indicates an “or” relationship between associated objects.

A network connection method, an electronic device, a readable storage medium, and a chip provided in the embodiments of this application are described in detail below by using specific embodiments and application scenarios thereof with reference to the accompanying drawings.

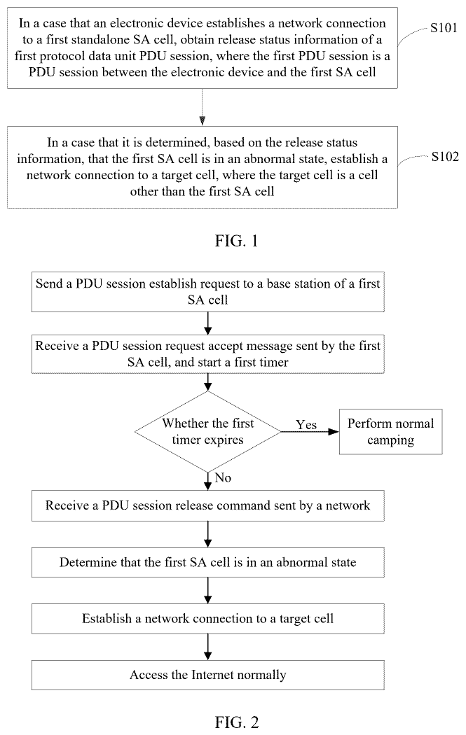

FIG. 1 is a schematic flowchart of a network connection method according to an embodiment of this application. The network connection method is applied to an electronic device, and the method includes the following steps:

Step S101: In a case that the electronic device establishes a network connection to a first standalone SA cell, obtain release status information of a first Protocol Data Unit (PDU) session, where the first PDU session is a PDU session between the electronic device and the first SA cell.

Step S102: In a case that it is determined, based on the release status information, that the first SA cell is in an abnormal state, establish a network connection to a target cell, where the target cell is a cell other than the first SA cell.

The electronic device may be various types of User Equipment (UE) carried by a user. For ease of understanding, UE is used below to represent the electronic device.

The first SA cell may be a 5th Generation (5G) Mobile Communication Technology SA cell.

That the electronic device establishes a network connection to the first standalone SA cell may mean that the UE establishes a network connection to a base station corresponding to the first SA cell. A specific network connection process may be as follows:

The UE sends a PDU session establish request to the base station of the first SA cell, where the PDU session establish request is used to request to establish the first PDU session; and in response to the PDU session establish request, the base station of the first SA cell sends a PDU session establish accept message to the UE, where the PDU session establish accept message is a PDU session establish accept message. After the two steps, a process of completing the network connection of the UE is completed, that is, a process of establishing the first PDU session is completed. In this case, the UE may normally access the Internet.

When a large quantity of different UEs establish network connections to the base station of the first SA cell at a same time, because the first SA cell may be unable to simultaneously meet Internet access requirements of the large quantity of UEs, the first SA cell actively disconnects network connections of some UEs, that is, disconnects PDU sessions of some UEs. After the PDU session between the first SA cell and the UE is disconnected, a PDU release command PDU session release command is sent to the UE.

Based on this, in an embodiment of this application, the release status information may include the PDU release command. In addition, cases in which received PDU release commands are in a normal state of the SA cell and states in which received PDU release commands are in an abnormal state of the SA cell may be predefined. Then, whether the first SA cell is in an abnormal state may be determined based on the release status information.

It may be understood that, that the first SA cell is in an abnormal state may mean that the first SA cell itself is faulty, or may mean that the first SA cell is in an overloaded state because excessive UEs are connected to the first SA cell.

The target cell may be various cells other than the first SA cell that can provide a network service for the electronic device. The electronic device is located within network coverage of the target cell.

In this implementation, in a case that the electronic device establishes the network connection to the first SA cell, whether the first SA cell is in an abnormal state is determined based on the release status information of the first PDU session, and in a case that the first SA cell is in an abnormal state, the network connection between the electronic device and the target cell is established. In this way, because whether the first SA cell is in an abnormal state may be identified in a timely manner based on the release status information of the first PDU session, and in a case that it is recognized that the first SA cell is in an abnormal state, a network connection of the electronic device is switched to another cell, so that the electronic device stores a normal network connection.

For example, the release status information includes a first time difference, and the first time difference includes a time difference between a time point at which the first PDU session is established and a time point at which the first PDU session is released. Before the establishing a network connection to a target cell, the method further includes:
in a case that the first time difference is less than a first preset value, determining that the first SA cell is in an abnormal state.

For example, a first timer may be preconfigured in the electronic device. When the electronic device receives the PDU session establish accept message, that is, when the electronic device successfully establishes the network connection to the first SA cell, the electronic device controls the first timer to start timing. When receiving the PDU session release command, that is, when disconnecting the network connection between the electronic device and the first SA cell, the electronic device controls the first timer to end timing. The first time difference may be obtained through reading of timing duration of the first timer.

It may be understood that the first time difference may be a relatively short time difference, for example, a value range of the first time difference may be 0 to 10 seconds. In other words, after the electronic device establishes the network connection to the first SA cell, the established network connection is immediately released by the first SA cell. In this case, it may be considered that the first SA cell is abnormal.

FIG. 2 is a schematic flowchart of a network connection method according to an embodiment of this application. The method includes the following steps:

After camping on a first SA cell, an electronic device establishes a data PDU, and sends a PDU session establish request to a base station of the first SA cell.

The base station of the first SA cell sends a PDU session establish accept message to the electronic device in response to the PDU session establish request. After receiving the PDU session establish accept message, the electronic device starts a first timer.

Before the first timer expires, if a PDU session release command is not received, the electronic device normally camps on the first SA cell. Timing duration that is set by the first timer is a size of the first time difference.

Before the first timer expires, if the PDU session release command is received, it is determined that the first SA cell is in an abnormal state, and a network connection between the electronic device and a target cell is established.

It may be understood that, after the first timer expires, if a network connection between the electronic device and the first SA cell is released, it is considered that the network connection is normally released, that is, the first SA cell is in a normal state. In this case, after the electronic device establishes the network connection to the first SA cell again, and after the electronic device successfully establishes the network connection to the first SA cell, the electronic device starts the first timer to be perform timing again, and repeats the foregoing determining process. In other words, if the network connection between the electronic device and the first SA cell is released before the first timer expires, it is determined that the first SA cell is in an abnormal state.

In addition, in another embodiment of this application, whether the first timer expires may be determined after the PDU session release command is received, to determine whether the first SA cell is in an abnormal state. For example, after the PDU session release command is received, if the first timer has expired, it is determined that the first SA cell is in a normal state. Correspondingly, after the PDU session release command is received, if the first timer does not expire, it is determined that the first SA cell is in an abnormal state.

In this implementation, a time difference between a time point at which the first PDU session is established and a time point at which the first PDU session is released is determined, and in a case that the time difference is less than a first preset value, it is determined that the first SA cell is in an abnormal state, that is, after the electronic device establishes the network connection to the first SA cell and the network connection is released in a relatively short time, it is determined that the first SA cell is in an abnormal state. In this way, whether the first SA cell is in an abnormal state is determined based on the release status information.

For example, the release status information includes a quantity of releasing times, and the quantity of releasing times includes a quantity of times that the first PDU session between the electronic device and the first SA cell is released within a preset period of time. Before the establishing a network connection to a target cell, the method further includes:
in a case that a first PDU session release command sent by the first SA cell is received within the preset time period, reestablishing the first PDU session with the first SA cell; and
in a case that the quantity of releasing times is greater than a second preset value, determining that the first SA cell is in an abnormal state.

The preset time period may be a relatively short time period, for example, may be 1 to 3 minutes. The preset quantity of times may be 3 to 5 times, that is, in a relatively short time period, the electronic device establishes a network connection to the first SA cell for a plurality of times, and network connections established in the plurality of times are all released. In this case, it may be determined that the first SA cell is in an abnormal state.

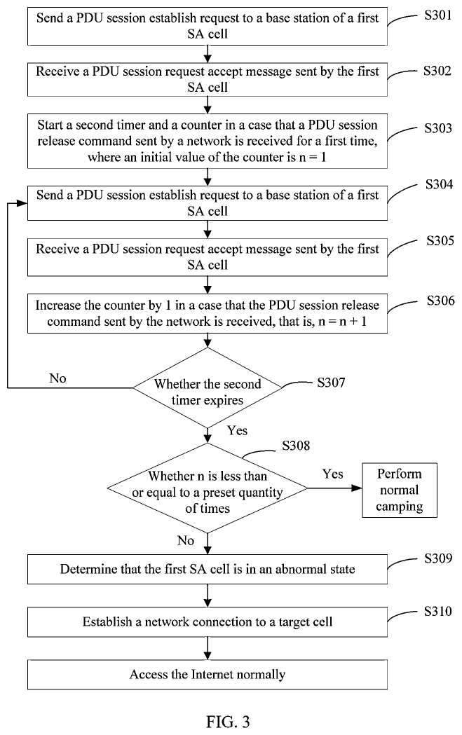

For example, as shown in FIG. 3, a network connection method is provided in an embodiment of this application. In some embodiments, the method includes the following steps:

Step 301: After camping on a first SA cell, an electronic device establishes a data PDU, and sends a PDU session establish request to a base station of the first SA cell.

Step 302: The base station of the first SA cell sends a PDU session establish accept message to the electronic device in response to the PDU session establish request, to establish a network connection.

Step S303: Start a second timer and a counter in a case that a PDU session release command is received for a first time, where timing duration of the second timer is a size of the foregoing preset time period, and an initial value of the counter is n=1.

Step S304: Send a PDU session establish request to the base station of the first SA cell again.

Step S305: The base station of the first SA cell sends a PDU session establish accept message to the electronic device in response to the PDU session establish request.

Step S306: In a case that the PDU session release command is received, increase the counter by 1, that is, n=n+1.

Step S307: Determine whether the second timer expires, and return to perform step S304 in a case that the second time does not expire.

Step S308: In a case that the second timer expires, determine whether n is less than or equal to a preset quantity of times, and if yes, perform normal camping.

Step S309: If n is greater than the preset quantity of times, determine that the first SA cell is in an abnormal state.

Step S310: Establish a network connection to a target cell, to access the Internet normally.

In this implementation, a quantity of times that the first PDU session between the electronic device and the first SA cell is released within the preset time period is determined, and in a case that the quantity of releasing times is greater than a second preset value, it is determined that the first SA cell is in an abnormal state, that is, when a quantity of times that a network connection between the electronic device and the first SA cell is released exceeds a specified quantity of times in a relatively short time, it is determined that the first SA cell is in an abnormal state. In this way, whether the first SA cell is in an abnormal state is determined based on the release status information.

In an embodiment of this application, whether the first time difference is a first preset value and whether the quantity of releasing times is greater than the second preset value may be simultaneously determined, to determine whether the first SA cell is in an abnormal state, where the first preset value is less than duration of the preset time period, that is, timing duration of the first timer is less than timing duration of the second timer.

For example, the electronic device is preconfigured with frequency information of at least two candidate cells, the at least two candidate cells include at least one of a second SA cell and a Long Term Evolution (LTE) cell, the target cell is any candidate cell in the at least two candidate cells, and the establishing a network connection to a target cell includes:
establishing the network connection to the target cell based on frequency information of the target cell.

For example, coverage ranges of neighboring cells of a same type usually have overlapping areas, and in addition, coverage ranges of cells of different types also have overlapping areas. Therefore, when the electronic device camps on the first SA cell, a network connection may be further established to another cell. A frequency of the candidate cell and a coverage range of the candidate cell may be preconfigured in the electronic device. In this way, when the first SA cell is in an abnormal state, the electronic device may determine, from configuration information, the at least two candidate cells that can normally provide a network service for the electronic device, and may determine the target cell from the at least two candidate cells. In addition, a network connection between the electronic device and the target cell is established based on a frequency of the target cell. A process of establishing the network connection between the electronic device and the target cell is similar to the foregoing process, that is, after a PUD session establish request is sent to a base station of the target cell, and a PUD session establish accept message sent by the base station of the target cell is received, a network connection process is completed.

In this implementation, in a case that the first SA cell is in an abnormal state, the network connection between the electronic device and the target cell is established. In this way, it can be ensured that an Internet access service can be normally provided for the electronic device.

For example, before the establishing a network connection to a target cell, the method further includes:
determining the target cell from at least one second SA cell in a case that the at least two candidate cells include the at least one second SA cell; and
determining the target cell from at least one LTE cell in a case that the at least two candidate cells do not include the second SA cell.

In some embodiments, the determining the target cell from at least one LTE cell in a case that the at least two candidate cells do not include the second SA cell may mean: determining the target cell from the at least one LTE cell in a case that the at least two candidate cells do not include the second SA cell and the at least two candidate cells include the at least one LTE cell.

In comparison with the LTE cell, an Internet access speed of an Internet access service provided by the SA cell is faster. Therefore, for example, in a case that the at least two candidate cells include the second SA cell, the target cell may be determined from the second SA cell, to improve network service quality. Correspondingly, in a case that the at least two candidate cells do not include the SA cell, the target cell is determined from the LTE cell, so that a network service can be normally provided for the electronic device.

For example, before the establishing a network connection to a target cell, the method further includes:
obtaining signal strength information of the at least two candidate cells; and
determining a candidate cell with strongest signal strength in the at least two candidate cells as the target cell.

The electronic device may directly download signal strength of the candidate cell.

In this implementation, the candidate cell with the strongest signal strength in the at least two candidate cells is determined as the target cell. In this way, network service quality is improved.

In another embodiment of this application, before the establishing a network connection to a target cell, the method further includes:
in a case that the at least two candidate cells include at least two second SA cells, determining a second SA cell with strongest signal strength in the at least two second SA cells as the target cell; and
in a case that the at least two candidate cells do not include the second SA cell and the at least two candidate cells include at least two LTE cells, determining an LTE cell with strongest signal strength in the at least two LTE cells as the target cell.

For example, in a case that it is determined, based on the release status information, that the first SA cell is in an abnormal state, the method further includes:
adding the first SA cell to a locally cached abnormal 5G SA cell list.

The abnormal 5G SA cell list may cache frequency information of a cell that is determined by the electronic device as an abnormal cell within preset duration. In this way, when connecting to a network, the electronic device may choose to establish a network connection to a cell other than the abnormal 5G SA cell list, to improve a network connection success rate. It may be understood that the first SA cell stores only the frequency information of the cell that is determined by the electronic device as an abnormal cell within the preset duration, and after the preset duration, the cell that is determined by the electronic device as abnormal is removed from the abnormal 5G SA cell list. In this way, it can be ensured that after such a cell is recovered to normal, the cell can normally provide a network service for the electronic device.

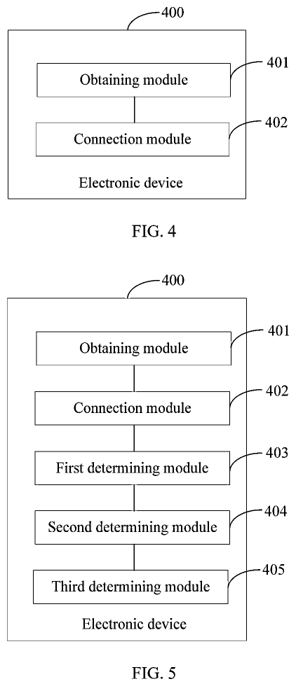

FIG. 4 is a schematic diagram of a structure of an electronic device 400 according to an embodiment of this application. The electronic device 400 includes:
an obtaining module 401, configured to: in a case that the electronic device 400 establishes a network connection to a first standalone SA cell, obtain release status information of a first protocol data unit PDU session, where the first PDU session is a PDU session between the electronic device 400 and the first SA cell; and
a connection module 402, configured to: in a case that it is determined, based on the release status information, that the first SA cell is in an abnormal state, establish a network connection to a target cell, where the target cell is a cell other than the first SA cell.

For example, the release status information includes a first time difference, and the first time difference includes a time difference between a time point at which the first PDU session is established and a time point at which the first PDU session is released. As shown in FIG. 5, the electronic device 400 further includes:
a first determining module 403, configured to: in a case that the first time difference is less than a first preset value, determine that the first SA cell is in an abnormal state.

For example, the release status information includes a quantity of releasing times, and the quantity of releasing times includes a quantity of times that the first PDU session between the electronic device 400 and the first SA cell is released within a preset period of time;
the connection module 402 is further configured to: in a case that a first PDU session release command sent by the first SA cell is received within the preset time period, reestablish the first PDU session with the first SA cell; and
the electronic device 400 further includes:
a second determining module 404, configured to: in a case that the quantity of releasing times is greater than a second preset value, determine that the first SA cell is in an abnormal state.

For example, the electronic device 400 is preconfigured with frequency information of at least two candidate cells, the at least two candidate cells include at least one of a second SA cell and a Long Term Evolution LTE cell, and the target cell is any candidate cell in the at least two candidate cells; and
the connection module 402 is configured to establish the network connection to the target cell based on frequency information of the target cell.

For example, the electronic device 400 further includes:
a third determining module 405, configured to determine the target cell from at least one second SA cell in a case that the at least two candidate cells include the at least one second SA cell; and
the third determining module 405 is further configured to determine the target cell from at least one LTE cell in a case that the at least two candidate cells do not include the second SA cell.

For example, the obtaining module 401 is further configured to obtain signal strength information of the at least two candidate cells; and
the electronic device 400 further includes:
a third determining module 405, configured to determine a candidate cell with strongest signal strength in the at least two candidate cells as the target cell.

In this implementation, in a case that the electronic device 400 establishes the network connection to the first SA cell, whether the first SA cell is in an abnormal state is determined based on the release status information of the first PDU session, and in a case that the first SA cell is in an abnormal state, the network connection between the electronic device 400 and the target cell is established, to ensure that the electronic device 400 can still connect to a network in a case that the first SA cell is abnormal, thereby improving a network connection effect of the electronic device 400.

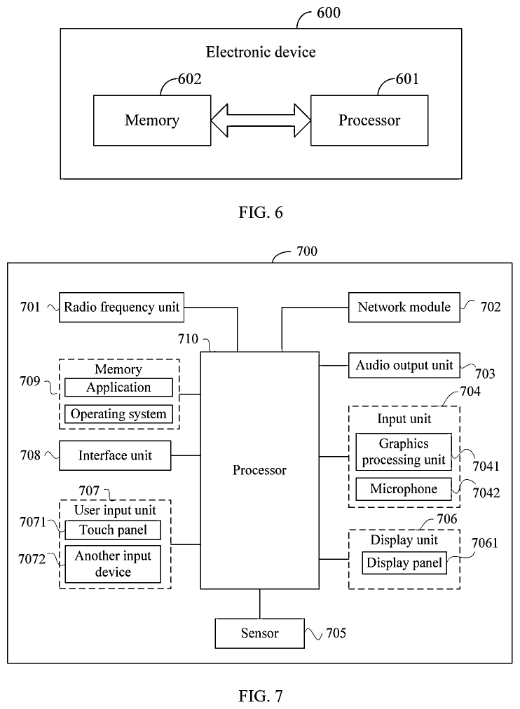

For example, as shown in FIG. 6, an embodiment of this application further provides another electronic device 600, including a processor 601, a memory 602, and a program or an instruction that is stored in the memory 602 and that is capable of being run on the processor 601. When the program or the instruction is executed by the processor 601, the processes of the foregoing embodiment of the network connection method are implemented, and a same technical effect can be achieved. To avoid repetition, details are not described herein again.

It should be noted that the electronic device in this embodiment of this application includes the mobile electronic device and the non-mobile electronic device.

FIG. 7 is a schematic diagram of a hardware structure of an electronic device according to an embodiment of this application.

An electronic device 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

The processor 710 is configured to: in a case that the electronic device establishes a network connection to a first standalone SA cell, obtain release status information of a first protocol data unit PDU session, where the first PDU session is a PDU session between the electronic device and the first SA cell.

The network module 702 is configured to: in a case that it is determined, based on the release status information, that the first SA cell is in an abnormal state, establish a network connection to a target cell, where the target cell is a cell other than the first SA cell.

For example, the processor 710 is configured to: in a case that the first time difference is less than a first preset value, determine that the first SA cell is in an abnormal state.

For example, the network module 702 is configured to: in a case that a first PDU session release command sent by the first SA cell is received within the preset time period, reestablish the first PDU session with the first SA cell.

The processor 710 is configured to: in a case that the quantity of releasing times is greater than a second preset value, determine that the first SA cell is in an abnormal state.

For example, the connection module 702 is configured to establish the network connection to the target cell based on frequency information of the target cell.

For example, the processor 710 is configured to determine the target cell from at least one second SA cell in a case that the at least two candidate cells include the at least one second SA cell.

The processor 710 is configured to determine the target cell from at least one LTE cell in a case that the at least two candidate cells do not include the second SA cell.

For example, the processor 710 is configured to obtain signal strength information of the at least two candidate cells.

The processor 710 is configured to determine a candidate cell with strongest signal strength in the at least two candidate cells as the target cell.

A person skilled in the art can understand that the electronic device 700 may further include the power supply (for example, a battery) that supplies power to each component. The power supply may be logically connected to the processor 710 by using a power supply management system, so as to manage functions such as charging, discharging, and power consumption by using the power supply management system. The structure of the electronic device shown in FIG. 7 does not constitute a limitation on the electronic device, and the electronic device may include more or fewer components than those shown in the figure, or combine some components, or have different component arrangements. Details are not described herein again.

It should be understood that in this embodiment of this application, the input unit 704 may include a Graphics Processing Unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (for example, a volume control button or a power on/off button), a trackball, a mouse, and a joystick. Details are not described herein. The memory 709 may be configured to store a software program and various data, including but not limited to an application program and an operating system. An application processor and a modem processor may be integrated into the processor 710, the application processor mainly processes an operating system, a user interface, an application program, and the like, and the modem processor mainly processes wireless communication. It may be understood that, in some embodiments, the modem processor may not be integrated into the processor 710.

An embodiment of this application further provides a readable storage medium. The readable storage medium stores a program or an instruction, and the program or the instruction is executed by a processor to implement the processes in the foregoing embodiment of the network connection method, and a same technical effect can be achieved. To avoid repetition, details are not described herein again.

The processor is a processor in the electronic device in the foregoing embodiment. The readable storage medium includes a computer-readable storage medium, such as a computer Read-Only Memory (ROM), a Random Access Memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the network connection method, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a software product. The computer software product is stored in a storage medium (for example, a ROM/RAM, a magnetic disk, or a compact disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A network connection method, executed by an electronic device, comprising:
when the electronic device establishes a network connection to a first Standalone (SA) cell, obtaining release status information of a first Protocol Data Unit (PDU) session, wherein the first PDU session is a PDU session between the electronic device and the first SA cell; and
when it is determined, based on the release status information, that the first SA cell is in an abnormal state, establishing a network connection to a target cell, wherein the target cell is a cell other than the first SA cell.

2. The method according to claim 1, wherein the release status information comprises a first time difference, the first time difference comprises a time difference between a time point at which the first PDU session is established and a time point at which the first PDU session is released, and before the establishing the network connection to the target cell, the method further comprises:
when the first time difference is less than a first preset value, determining that the first SA cell is in an abnormal state.

3. The method according to claim 1, wherein the release status information comprises a quantity of releasing times, the quantity of releasing times comprises a quantity of times that the first PDU session between the electronic device and the first SA cell is released within a preset period of time, and before the establishing the network connection to the target cell, the method further comprises:
when a first PDU session release command sent by the first SA cell is received within the preset time period, reestablishing the first PDU session with the first SA cell; and
when the quantity of releasing times is greater than a second preset value, determining that the first SA cell is in an abnormal state.

4. The method according to claim 1, wherein the electronic device is preconfigured with frequency information of at least two candidate cells, the at least two candidate cells comprise at least one of a second SA cell or a Long Term Evolution (LTE) cell, the target cell is any candidate cell in the at least two candidate cells, and the establishing the network connection to the target cell comprises:
establishing the network connection to the target cell based on frequency information of the target cell.

5. The method according to claim 4, wherein before the establishing the network connection to the target cell, the method further comprises:
determining the target cell from at least one second SA cell when the at least two candidate cells comprise the at least one second SA cell; and
determining the target cell from at least one LTE cell when the at least two candidate cells do not comprise the second SA cell.

6. An electronic device, comprising a processor and a memory storing instructions, wherein the instructions, when executed by the processor, cause the processor to perform operations comprising:
when the electronic device establishes a network connection to a first Standalone (SA) cell, obtaining release status information of a first Protocol Data Unit (PDU) session, wherein the first PDU session is a PDU session between the electronic device and the first SA cell; and
when it is determined, based on the release status information, that the first SA cell is in an abnormal state, establishing a network connection to a target cell, wherein the target cell is a cell other than the first SA cell.

7. The electronic device according to claim 6, wherein the release status information comprises a first time difference, the first time difference comprises a time difference between a time point at which the first PDU session is established and a time point at which the first PDU session is released, and
before the establishing the network connection to the target cell, when the instructions is executed by the processor, cause the processor to further perform operations comprising:
when the first time difference is less than a first preset value, determining that the first SA cell is in an abnormal state.

8. The electronic device according to claim 6, wherein the release status information comprises a quantity of releasing times, the quantity of releasing times comprises a quantity of times that the first PDU session between the electronic device and the first SA cell is released within a preset period of time, and
before the establishing the network connection to the target cell, when the instructions is executed by the processor, cause the processor to further perform operations comprising:
when a first PDU session release command sent by the first SA cell is received within the preset time period, reestablishing the first PDU session with the first SA cell; and
when the quantity of releasing times is greater than a second preset value, determining that the first SA cell is in an abnormal state.

9. The electronic device according to claim 6, wherein the electronic device is preconfigured with frequency information of at least two candidate cells, the at least two candidate cells comprise at least one of a second SA cell or a Long Term Evolution (LTE) cell, the target cell is any candidate cell in the at least two candidate cells, and
the establishing the network connection to the target cell comprises:
establishing the network connection to the target cell based on frequency information of the target cell.

10. The electronic device according to claim 9, wherein before the establishing the network connection to the target cell, when the instructions is executed by the processor, cause the processor to further perform operations comprising:
determining the target cell from at least one second SA cell when the at least two candidate cells comprise the at least one second SA cell; and
determining the target cell from at least one LTE cell when the at least two candidate cells do not comprise the second SA cell.

11. A non-transitory computer readable storage medium storing instructions, that, when executed by a processor of an electronic device, cause the processor to perform operations comprising:
when the electronic device establishes a network connection to a first Standalone (SA) cell, obtaining release status information of a first Protocol Data Unit (PDU) session, wherein the first PDU session is a PDU session between the electronic device and the first SA cell; and
when it is determined, based on the release status information, that the first SA cell is in an abnormal state, establishing a network connection to a target cell, wherein the target cell is a cell other than the first SA cell.

12. The non-transitory computer readable storage medium according to claim 11, wherein the release status information comprises a first time difference, the first time difference comprises a time difference between a time point at which the first PDU session is established and a time point at which the first PDU session is released, and
before the establishing the network connection to the target cell, when the instructions is executed by the processor, cause the processor to further perform operations comprising:
when the first time difference is less than a first preset value, determining that the first SA cell is in an abnormal state.

13. The non-transitory computer readable storage medium according to claim 11, wherein the release status information comprises a quantity of releasing times, the quantity of releasing times comprises a quantity of times that the first PDU session between the electronic device and the first SA cell is released within a preset period of time, and
before the establishing the network connection to the target cell, when the instructions is executed by the processor, cause the processor to further perform operations comprising:
when a first PDU session release command sent by the first SA cell is received within the preset time period, reestablishing the first PDU session with the first SA cell; and
when the quantity of releasing times is greater than a second preset value, determining that the first SA cell is in an abnormal state.

14. The non-transitory computer readable storage medium according to claim 11, wherein the electronic device is preconfigured with frequency information of at least two candidate cells, the at least two candidate cells comprise at least one of a second SA cell or a Long Term Evolution (LTE) cell, the target cell is any candidate cell in the at least two candidate cells, and
the establishing the network connection to the target cell comprises:
establishing the network connection to the target cell based on frequency information of the target cell.

15. The non-transitory computer readable storage medium according to claim 14, wherein before the establishing the network connection to the target cell, when the instructions is executed by the processor, cause the processor to further perform operations comprising:
determining the target cell from at least one second SA cell when the at least two candidate cells comprise the at least one second SA cell; and
determining the target cell from at least one LTE cell when the at least two candidate cells do not comprise the second SA cell.
